(19) United States
(12) Patent Application Publication
(10) Pub. No.: US 2013/0268834 A1
(43) Pub. Date: Oct. 10, 2013

(54) CREATING INTERACTIVE FORMS FROM APPLICATIONS' USER INTERFACE

(71) Applicants: ROLF KRANE, Wiesloch (DE); Udo Klein, Maximiliansau (DE)

(72) Inventors: ROLF KRANE, Wiesloch (DE); Udo Klein, Maximiliansau (DE)

(21) Appl. No.: 13/438,887

(22) Filed: Apr. 4, 2012

(51) Int. Cl. G06F 17/00

(52) U.S. Cl. 715/222

(57) ABSTRACT

In one aspect, an interactive form container is generated for creation of an interactive form based on a UI of an application. The interactive form container establishes communication with the UI of the application. A data is received indicative of interactions with the UI of the application to execute a task associated with the application. Based on the interactions, a script records the interactions with the UI. In another aspect, copied UI objects from the UI of the application are added to the interactive form container to create the UI of the interactive form. The UI of the interactive form in association with the recorded script are stored to create the interactive form.

### BACKGROUND

Business applications enable enterprises to execute and optimize business strategies and perform essential, industry-specific, and supporting processes. They are usually designed to work with different types of software. Organizations are increasing demand for working with a variety of tools that support their daily working activities. The support for executing end-to-end business processes allows them to operate more efficiently and effectively. Business scenarios depict interactions with external agents. For example customers, suppliers, competitors, agents from the regulatory environment, etc. Managing enterprise data gives users the ability to define, integrate and retrieve data from internal and external applications or communication.

Working with an application and performing interactions with it can be time-consuming Some business applications imply a high level of complexity. Entering data and navigating through the user interface (UI) of a business application can be facilitated by providing an interactive form for data entry. Interactive forms can be used for automating and streamlining form-based communication with applications.

### SUMMARY

Various embodiments of systems and methods for creating interactive forms from applications' user interface are described herein. In one embodiment, the method includes generating an interactive form container and establishing communication between the UI of the application and the interactive form container. Interactions with the UI of the application that are related to execution of a task associated with the application are received. The processor is recording a script. The script is descriptive of the interactions with the UI of the application for the execution of the task. The method also includes adding copies of UI objects from the UI of the application to the interactive form container to create a UI of the interactive form. The UI objects that are copied are associated with execution of the task. The UI of the interactive form in association with the recorded script are stored to create the interactive form. Upon processing the interactive form, the script is executed and uses filled in data via the UI of the interactive form to accomplish the task associated with the interactive form.

In another embodiment, the system includes at least one processor for executing program code and memory, comprising a generating module to generate an interactive form container and to communicate with the UI of the application. A receiving module connected with the generating module receives data from interactions with the UI of the application. The interactions are in association with a task execution with the UI of the application. A script module records a script descriptive of the interactions with the application. A UI creation module in communication with the script module creates the UI of the interactive form by adding copies of UI objects from the UI of the application to the interactive form container. The added copies of the UI objects are associated with the task execution. A storing module communicates with both the script module and the UI creation module and stores the UI of the interactive form and the recorded script and thus creates the interactive form.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an embodiment of environment for creation and processing of an interactive form based on a UI of an application.

FIG. 2A is an exemplary screenshot, depicting an embodiment of environment for creation of a UI of an interactive form.

FIG. 2B is an exemplary screenshot, depicting an embodiment of environment for recoding of a script for an interactive form.

FIG. 3 is a block diagram illustrating an embodiment of a system for creating an interactive form based on a UI of an application.

FIG. 4 is a flow diagram illustrating an embodiment of a method for creating an interactive form based on a UI of an application.

FIG. 5 is a flow diagram illustrating an embodiment of a method for creating, editing and processing of an interactive form.

FIG. 6 is a block diagram illustrating a computing environment in which the techniques described for creating an interactive form can be implemented, according to one embodiment.

### DETAILED DESCRIPTION

Embodiments of techniques for creating interactive forms from applications' user interface are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

Interactive forms may be designed to assist and support regularly executed tasks in a complex application. They can be modeled based on the UI of an external application, for example, a business application. Thus, interactive forms present a simple model for communication with an application by providing a UI and recording a script that can be executed. The script can be used to automate the processing of the interactive form that is designed to accomplish a specific task. Creating an interactive form covers generating an interactive form container that is in communication with the UI of the application, recording a script corresponding to received interactions with the UI, and creating a UI of the interactive form. In addition, the script describes the interactions made when performing a task using the UI of the application. The UI of the interactive form is created when adding copies of UI objects from the UI of the application to the interactive form container when executing the task with the UI. The created UI and the script are stored in association and create the interactive form.

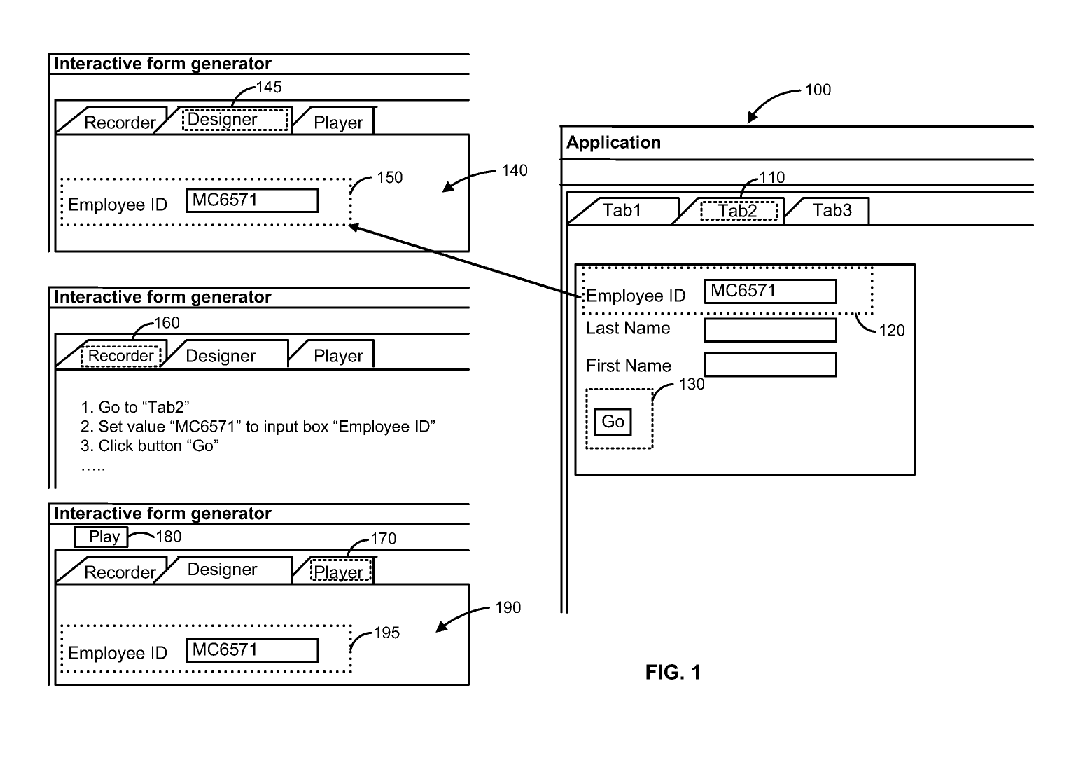

FIG. 1 is a block diagram illustrating an embodiment of environment for creating an interactive form based on a UI of an application. An application 100 is a software application that can be used for accomplishing different tasks, for example, searching for an employee, entering details data for employees, requesting approvals, etc. In one embodiment, there are tabs in the UI of the application 100. For example, the application 100 may be a business application that contains information about employees of a company. A user may search for displaying information about an employee by navigating through different screens, menus, tabs, etc., part of the application 100 and using different criteria, for example, employee identification number, first name, last name, etc.

In one embodiment, an interactive form can be created, for example, to simplify and automate the change of a position title of an employee in the application 100. In one embodiment, creating the interactive form for changing of a position title of an employee searched by the employee ID includes generating an interactive form container where a UI for the interactive form can be created and a script can be recorded. The interactive form container can establish communication with the UI of the application. In one embodiment, the container may be used to create the UI, based on the UI of an application, and to store a record of a script descriptive of the steps that can be done in the application to perform a task. Creating the UI of the interactive form is based on UI objects from the application 100. The UI of the interactive form can be created by adding copies of UI objects from the UI of the application 100. The UI objects from the application 100 can come from different screens from the UI of the application 100. These screens can be the screens that a user visits when performing a task, such as changing the position title of an employee. The UI objects that are copied are associated with performing a task that can include a couple of steps to be accomplished. For example, changing the position title of an employee may have several steps such as searching for an employee, editing the position title of the employee and saving the change in the application 100.

To change a position title for an employee in the application 100, the employee should be found. Then, the detailed information for the employee can be presented and edited to reflect the change of the position title of the employee. In one embodiment, to find and display information about an employee in the application 100, Tab2 110 is selected and on the main screen there are fields for searching employees. For example, a search can be made based on the employee ID. For example, part of the UI for such an interactive form can be such as a UI 140 which is displayed in a Designer view 145. In the Designer view 145, there is a UI object 150 “Employee ID” that corresponds to the UI object 120 from the application 100. The UI object 150 is a copy of the UI object 120. The UI Object 120 from the application 100 can be added to the Designer view 145. The employee ID can be filled in the UI object 120 “Employee ID”. The UI object 120 is a text field that is labeled with the name “Employee ID”. If you search for an employee with an employee ID—“MC6571”, the search criteria “MC6571” can be entered in the text box and then a push button “Go” 130 can be selected. Thus, creating the UI of the interactive form includes a UI object for searching of an employee in the application 100 with employee ID equal to “MC6571”.

In one embodiment, by recording a script, the steps of navigation and definition of search criteria in the UI of the application 100 are stored. In a Recorder view 160, there is a script that records the steps that can be made in the UI of the application 100. These steps include searching for an employee with the ID “MC6571”. These steps follow the navigation through tabs in the UI, entering search criteria into a field in the UI, and selecting a push button (e.g. the push button “Go” 130). The steps that can be recorded in a script are not limited to the given examples. When changing the position title of an employee in application 100, additional steps are performed for editing the employee's position title. After filling data about the position title of the employee that should be updated (changed), the filled in data can be stored thus saving the new employee's information. The steps include interactions with the application 100 that are executed during processing of the task. In one embodiment, when an interactive form is created, there is a UI associated with a recorded script that can represent and simulate task execution in an application, such as the application 100.

In one embodiment, in a Player view 170, the interactive form for changing the position title of an employee using the employee ID in the application 100 is presented in an executable format. An interactive form 190 is displayed with the UI of the interactive form that is created in the Designer view 145 with copied UI objects from an application, such as the application 100. In one embodiment, the interactive form 190 can be processed by selecting the button Play 180 that can activate the execution of the script based on the data that is filled in the UI of the interactive form. The user of the interactive form can change the position title of an employee with an employee ID defined in the UI object 195 “Employee ID” in the Player view 170. For example, the search criteria can be “MC6666”. In one embodiment, the user may enter “MC6666” in the text box and process the form by the button Play 180. The processing of the interactive form can execute the steps from the recorded script and apply the data entered in the UI of the interactive form.

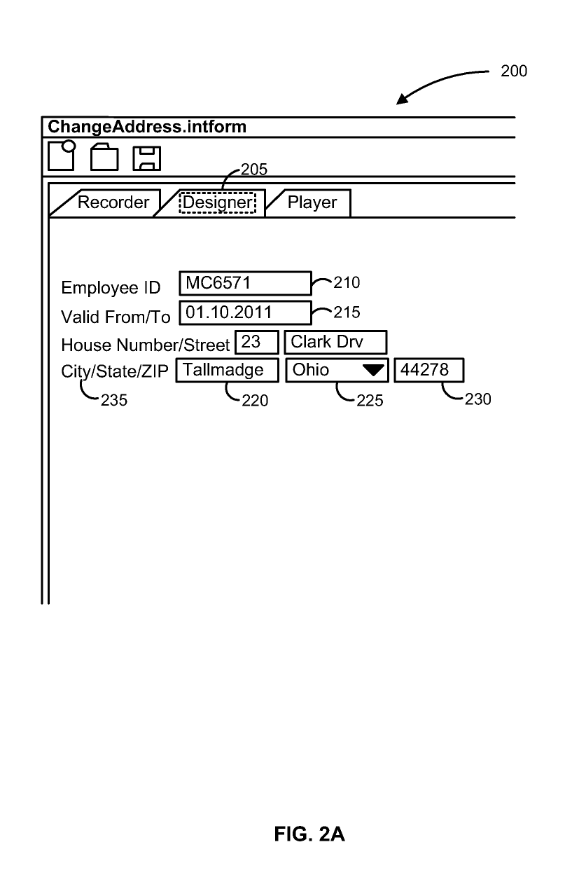

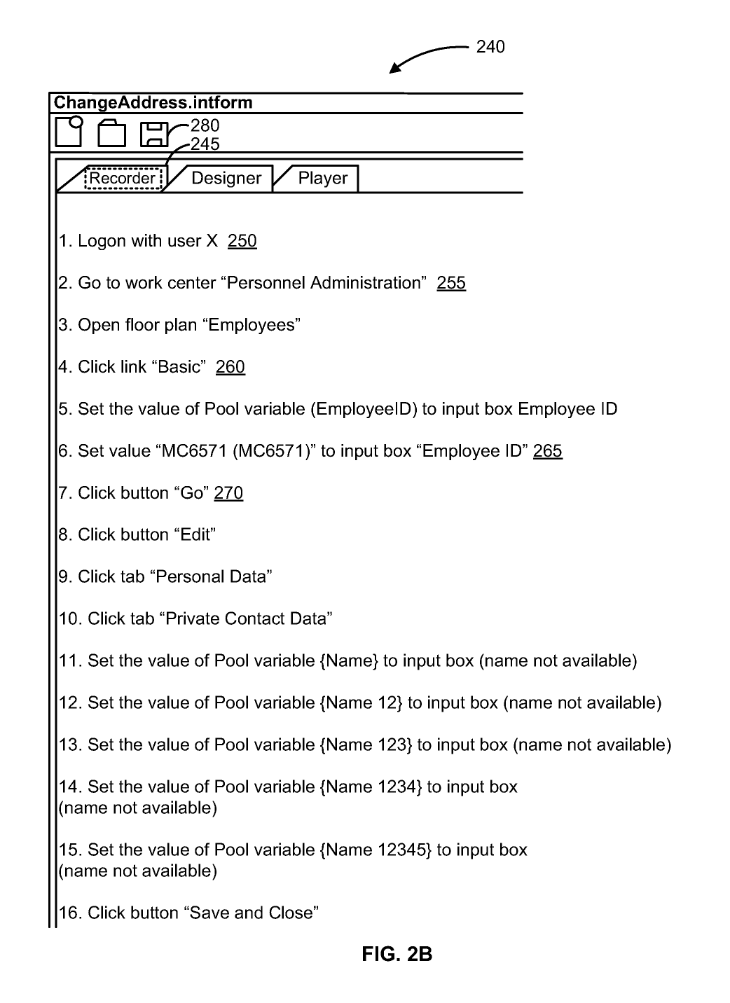

FIG. 2A is an exemplary screenshot, depicting an embodiment of environment for creation of a UI 200 of an interactive form. The UI 200 is presented in a Designer 205 view for an interactive form, such as the interactive form 190. In one embodiment, the Designer 205 view represents a designer area of an interactive form container that can include UI objects. In one embodiment, the added UI objects in the Designer 205 view can be objects for presenting and entering information about an employee and detailed information for the employee's address. Block 210 is a text box that contains an identification number of the employee. Block 215 is a box that contains a date data value which represents the validity of the address that is presented in the UI 200. In an embodiment, the values that are entered in block 215 are validated to reflect the data model of the date value that is required in the interactive form. Block 220, 225 and 230 represent the city, state and zip code of the employee's address respectively. Block 220 is a text box that contains the name of the city—“Tallmadge”. Block 225 is a drop-down list for the state of the employee's address, which is “Ohio”. In an embodiment, the drop-down list in block 225 has a defined list of possible options to choose from. The options come with the UI object that can be copied from an application (such as the application 100) and added in the UI of the interactive form. In one embodiment, transferring UI objects from the UI of an application can be done by a drag and drop operation, selecting and clicking in the UI of the application, etc. Block 230 is a text box that contains a zip code. The text box expects the entered data to be compliant with the data model that comes from the application, which is used for creating the interactive form. For example, the data model of the text box may require a five digit code that does not start with zero. Block 235 is a label that is part of the UI of the interactive form. The UI 200 of the interactive form can be edited to reflect the needs for the creation of an interactive form.

FIG. 2B is an exemplary screenshot, depicting an embodiment of environment for recoding of a script 240 for an interactive form. The script 240 is presented in a Recorder 245 view for creating the interactive form. In one embodiment, the script 240 shows a number of actions that are received as interactions with steps performed with an application, such as the application 100. In one embodiment, the interactions with the application are those actions that a user may perform in order to define or change information about an employee's address. In an embodiment, the interactions are recorded in a sentence style steps, as in 250—“Logon with user X”. In the script 240, there are steps that describe window openings, such as in 255—“Go to work center “Personnel Administration” “, which describes the interaction of opening a new window “Personnel Administration” in the UI of the application. At 260, the interaction with the application that is described is a user action of opening a link “Basic”, which is present in the UI of an application. At 265, the interaction with the application is filling in an input box for the “Employee ID” with the value “MC6571”. At 270, the action, which is described, is clicking on a button from the UI of the application. The description in block 270 shows the name of the button—“Go”, which exists in the UI of the application. Following the actions from the script 240 may result in entering information about the address of an employee in the UI of an application, such as the application 100. According to an embodiment, button 280 can be used to trigger saving of the defined interactive form with the script 240 and a UI, such as the UI 200.

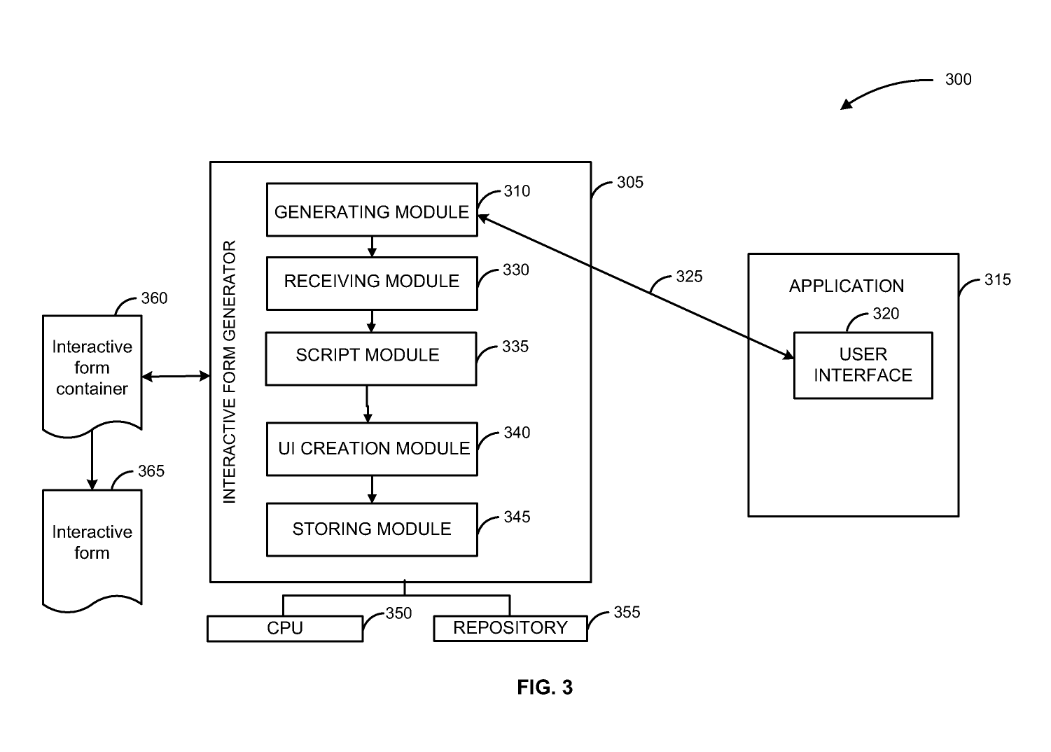

FIG. 3 is a block diagram illustrating an embodiment of a system 300 for creating an interactive form with a UI and a script. The interactive form has a UI of a structured set of UI objects that displays information. The interactive form may react to events triggered by a user. For instance, the user can enter data in the interactive form. The system 300 includes an interactive form generator 305 and an application 315 with user interface (UI) 320. In one embodiment, the interactive form generator 305 includes a generating module 310, a receiving module 330, and a script module 335.The generating module 310 establishes a communication channel 325 with the UI 320 to generate an interactive form container 360 and is in connection with the UI 320 to create an interactive form 365. In one embodiment, the interactive form container 360 includes UI objects and records the script. The script reflects the interactions with the UI 320 when performing a task, for example, changing a position title. The generating module is in relation to the receiving module 330 that receives data indicating that there are interactions with the UI 320 of the application 315, such as the application 100 (FIG. 1). The interactions with the UI are related to execution of a task with the application's UI.

In one embodiment, the UI 320 of the application 315 is used to create the UI of the interactive form. Different applications may implement different UI technologies for building a UI layer. For example, eXtensible HyperText Markup Language (xHTML); HyperText Markup Language (HTML); Active Server Pages (ASP) by Microsoft Corporation, Redmond, Wash., United States; Web Dynpro for ABAP™ developed by SAP A G, Walldorf, Germany; Flash® originally developed by Macromedia Inc., San Francisco, Calif., United States, Flex® provided by Adobe Systems Inc., San Jose, Calif., United States. Different UI technologies would require the usage of different manners of communication between applications. In one embodiment, the UI 320 of the application 315 may be a GUI.

The script module 335 records a script describing the interactions with the UI 320. The script module 335 is in association with a receiving module 330. In one embodiment, the interactions with the UI 320 that are described in the script can be related to navigation through the UI 320 of an application 315. Also, the interactions may include actions that are performed for executing a task. In one embodiment, such interactions may be following a menu path provided in the UI and performing actions. For example, such actions can be providing commands, selecting fields, pushing buttons, opening tabs, moving scrollbars, defining search criteria, filling in text boxes, etc. In another embodiment the performed actions can be user actions. According to an embodiment, the interactions may be provided from a keyboard, movement of the computer mouse, selection through a touchscreen, etc. In one embodiment, the interactive form generator 305 can be associated with hardware, software, and data resources. In one embodiment, the interactive form generator 305 is associated with a Central Processing Unit (CPU) 350 and a repository 360 to assist the process of creation of interactive forms. The CPU 350 is used to execute the program code. In one embodiment, the repository 360 is used for storing the interactive forms in a file format.

In one embodiment, the interactive form generator 305 includes a UI creation module 340 and a storing module 345. The UI creation module 340 is associated with the script module 335 and receives copies of UI objects from a UI 320 of an application 315. The UI creation module 340 adds copies of UI objects from the UI 320 of the application to an interactive form container to create the UI of the interactive form. The UI objects that are copied and added in the interactive form container are used for accomplishing a task that can be executed with the application 315 through the UI 320. For example, transferring UI objects from the UI 320 of the application 315 can be done by a drag and drop operation, or some other instructions that allow movement of UI objects. The UI of the interactive form may include graphical user interface (GUI) objects.

In one embodiment, copied UI objects transfer information about the design of the UI objects. For example, UI object 120 that is copied in an interactive form container has the same design as the UI object 150. In addition, the copied UI objects contain information about the data model of the original UI objects. In one embodiment, adding a copied UI object into the UI of an interactive form may insert a field with the design of a text field and a data model such as a data model for a date data value. In an embodiment, the UI creation module 340 may receive an action of filling in the interactive form thus providing content in it. Examples of actions for filling in content in the interactive form can be inserting numbers, characters or text in input fields; inserting check marks in check boxes; selecting items from a drop-down list, etc. In one embodiment, the filled in content can be validated. For instance, if the model for entering date data values is specified as “YYYY-MM-DD” and the received action with filled in content is “02-02-2012”, the validation of the filled in content may determine that the content does not comply with the data model and may require the content to be changed to “2012-02-02”.

According to an embodiment of the system 300, the interactive form generator 305 is further operable to edit the UI of the interactive form. For example, the UI objects from the UI 320 of the application 315 when copied and added to the interactive form container to create the interactive form can be rearranged, resized, etc. In an embodiment, additional UI elements, not part of the application 315, may be inserted into the UI of the interactive form. Their form, size and appearance may be changed as well.

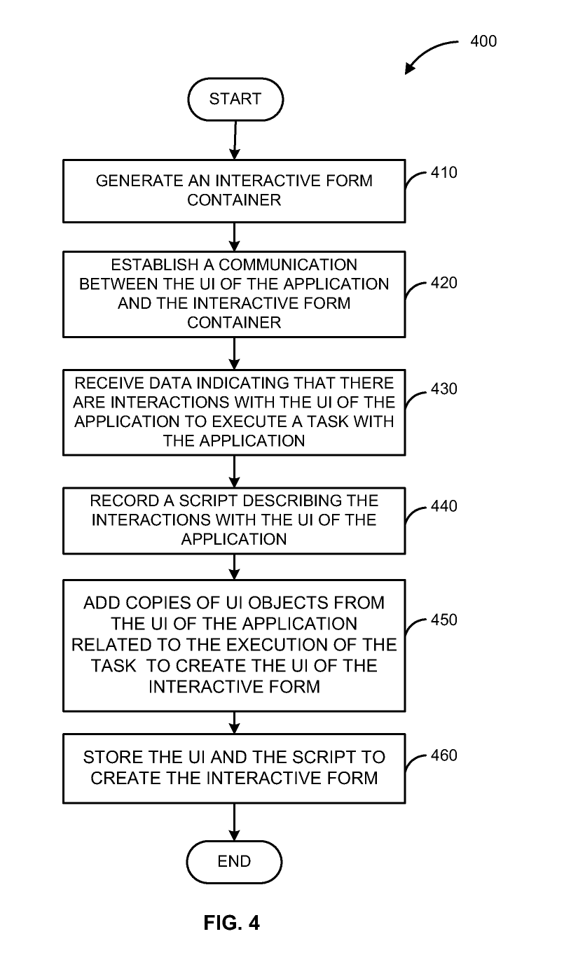

FIG. 4 is a flow diagram illustrating an embodiment of a method 400 for creating an interactive form based on a UI of an application. At process step 410, an interactive form container is generated to be used for the creation of the interactive form. Communication between the interactive form container and the UI of the application is established at process step 420. Further, at process step 430 there is data that is received to indicate interactions with the UI of the application. These interactions are related to execution of a task with the UI of the application. Based on the received data for the interactions, at process step 440 a script is recorded in the interactive form container. The script describes interactions with the application, for example, steps for navigating through the UI of the application to perform a specific task. At process step 450, copies of UI objects from the UI of the application are added into the interactive form container to create the UI of the interactive form. The UI and the script are stored at process step 460 and thus create the interactive form which can be processed. When processing the interactive form, there is filled-in data in the form and the script can be executed using the data. Processing the form can result in accomplishing a task with the application requested by the interactive form.

In one embodiment, the interactions with the UI that are recorded in the script, can be going through different screens, navigating with menus, selecting buttons, entering data, checking options, etc. The copied and added UI objects can contain information about design and data model of the UI objects. In one embodiment, after recording the script and storing the UI with the script, an action can be received for filling in the interactive form with content. The content that is filled in may be validated according to the data model defined for the UI objects that are added in the interactive form container from the UI of the application. In one embodiment, the interactive form can be saved as a file with a data schema. In one embodiment, the file can be in an eXtensible Markup Language (XML) format. For example, the saved files can be stored in a repository, such as repository 355. The saved interactive forms can be invoked and filled in with data to request an execution of a task with the application and thus accomplishing the task by the form's execution. The UI of the interactive form can be edited, for example, it can be rearranged. In one embodiment, the UI of the interactive form includes UI objects that are inserted from different sources, apart from an application, such as application 315. In one embodiment, the UI objects can be GUI objects.

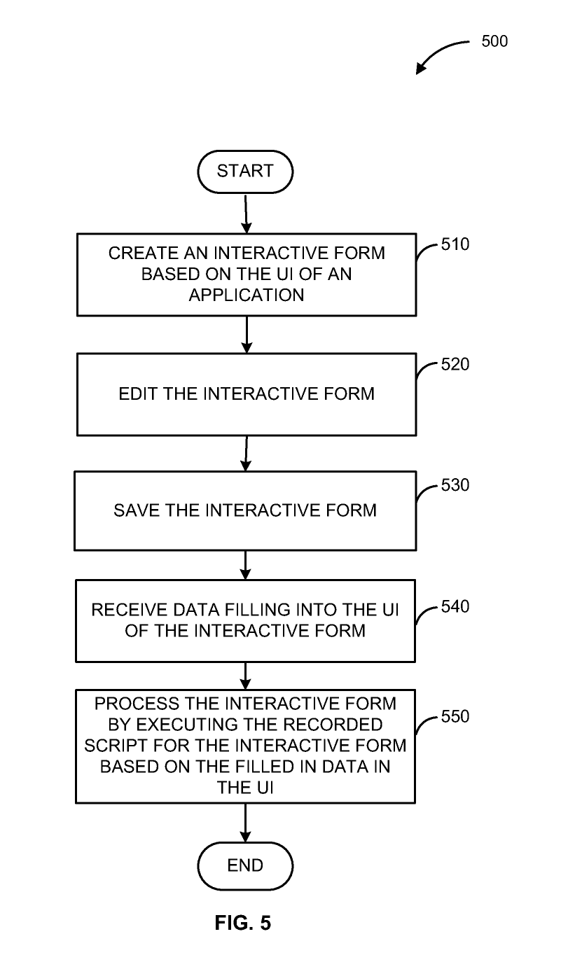

FIG. 5 is a flow diagram illustrating an embodiment of a method 500 for creating, editing and processing an interactive form. According to one embodiment, at process step 510 an interactive form is created based on a UI of an application, such as application 315. The interactive form can store a UI in relation to a script. At process step 520, the created interactive form can be edited which can include changing the arrangement of UI objects, inserting other UI objects, changing the layout and design of UI objects part of the UI of the interactive form. At process step 530, the interactive form can be saved. For example, it can be saved in an executable file which can be loaded and processed. When the interactive form is created, at process step 540, data can be inserted in the UI of the interactive form's UI objects to define what should be updated to perform a particular task. For example, if the address of an employee can be changed in an application (e.g. application 100), and there is an interactive form to automate the execution of the change, there would be fields for entering some identification of the person and for defining the address. At process step 550, the interactive form is processed which invokes the recorded script for the created interactive form. The script is executed using the filled in data in the interactive form that is received at process step 540.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

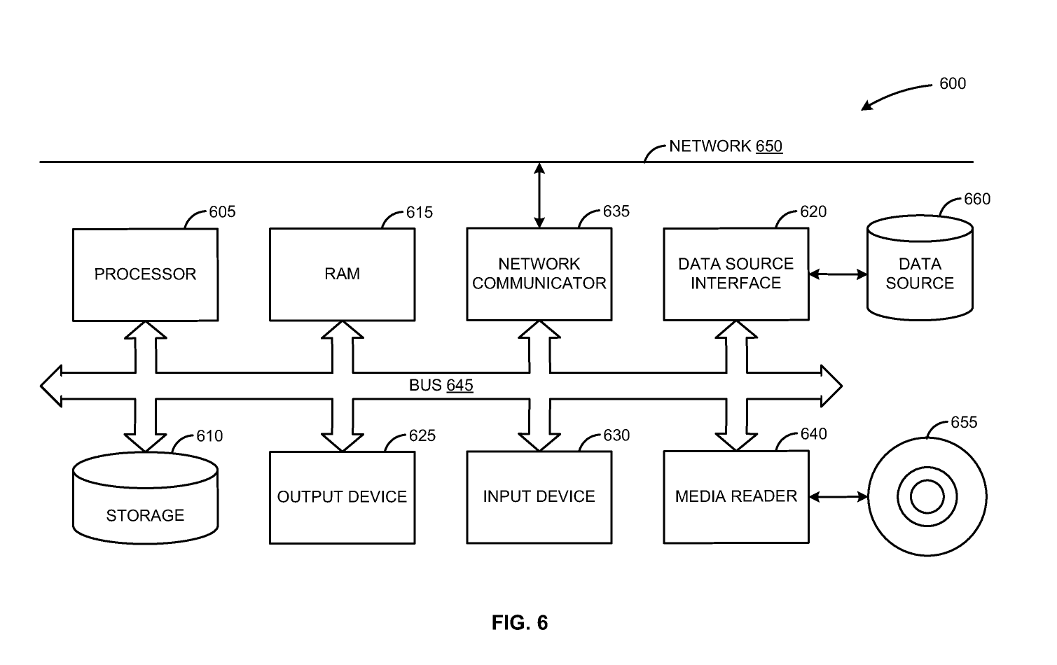

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method executed on a processor for creating an interactive form based on a user interface (UI) of an application, the method comprising:
generating an interactive form container;
establishing communication between the UI of the application and the interactive form container;
receiving first data indicative of interactions with the UI of the application related to execution of a task associated with the application;
based on the interactions, the processor recording a script corresponding to the interactions with the UI of the application;
adding copies of one or more UI objects from the UI of the application to the interactive form container to create a UI of the interactive form, wherein the one or more UI objects are associated with the execution of the task; and
storing the UI of the interactive form in association with the recorded script to create the interactive form, wherein the interactive form, upon processing, executes the script based on second data indicative of filling data via the UI of the interactive form.

2. The method of claim 1, wherein the interactions comprise steps related to navigating through the UI of the application and one or more actions for execution of the task with the application.

3. The method of claim 1, further comprising:
receiving the second data indicative of filling data into the created UI of the interactive form;
processing the interactive form to accomplish the task based on the filled second data by executing the recorded script in the interactive form container.

4. The method of claim 3, wherein adding the copies of the one or more UI objects comprises transferring information about design and data model of the copied one or more UI objects.

5. The method of claim 3, further comprising receiving third data indicative of editing the interactive form.

6. The method of claim 4, wherein receiving the second data indicative of filling the data into the created UI of the interactive form comprises validating the data based on the information about the design and the data model of the one or more UI objects.

7. The method of claim 1, wherein storing the UI of the interactive form in association with the recorded script further comprises saving the interactive form in a file with a data schema.

8. A computer system for creating an interactive form based on a user interface (UI) of an application, the system comprising:
a processor; and
a memory in association with the processor storing instructions related to:
a generating module to generate an interactive form container and to establish communication between the UI of the application and the interactive form container;
a receiving module in relation to the generating module to receive first data indicative of interactions with the UI of the application related to execution of a task associated with the application;
a script module in relation to the receiving module to record a script corresponding to the interactions with the UI of the application;
a UI creation module in relation to the script module to add copies of one or more UI objects from the UI of the application to the interactive form container to create a UI of the interactive form, wherein the one or more UI objects are associated with the execution of the task; and
a storing module in relation to the script module and the UI creation module to store the UI of the interactive form in association with the recorded script to create the interactive form, wherein the interactive form, upon processing, executes the script based on second data indicative of filling data via the UI of the interactive form.

9. The system of claim 8, wherein the interactions comprise steps related to navigating through the UI of the application and one or more actions for execution of the task.

10. The system of claim 8, wherein the memory further stores instructions related to a processing module to receive the second data indicative of filling data into the created UI of the interactive form and to process the interactive form to accomplish the task based on the filled second data by executing the recorded script in the interactive form container.

11. The system of claim 9, wherein the UI creation module is further operable to transfer information about design and data model of the copied one or more UI objects.

12. The system of claim 9, wherein the UI creation module is further operable to receive a user action editing the interactive form.

13. The system of claim 11, wherein the processing module is further operable to validate the second filled data based on the information about the design and the data model of the copied one or more UI objects.

14. An article of manufacture for creating an interactive form based on a user interface (UI) of an application, comprising a non-transitory computer readable storage medium including executable instructions, which when executed by a computer, cause the computer to:
generate an interactive form container;
establish communication between the UI of the application and the interactive form container;
receive first data indicative of interactions with the UI of the application related to execution of a task associated with the application;
based on the interactions, record a script corresponding to the interactions with the UI of the application;
add copies of one or more UI objects from the UI of the application to the interactive form container to create a UI of the interactive form, wherein the one or more UI objects are associated with the execution of the task; and
store the UI of the interactive form in association with the recorded script to create the interactive form, wherein the interactive form, upon processing, executes the script based on second data indicative of filling data via the UI of the interactive form.

15. The article of manufacture of claim 14, wherein the interactions comprise steps related to navigating through the UI of the application and one or more actions for execution of the task with the application.

16. The article of manufacture of claim 14, further comprising instructions, which when executed by a computer, cause the computer to:
receive the second data indicative of filling data into the created UI of the interactive form;
process the interactive form to accomplish the task based on the filled second data by executing the recorded script in the interactive form container.

17. The article of manufacture of claim 16, wherein the instructions to add the copies of the one or more UI objects comprises instructions which when executed by a computer, cause the computer to transfer information about design and data model of the copied one or more UI objects.

18. The article of manufacture of claim 16, further comprising instructions, which when executed by a computer, cause the computer to receive third data indicative of editing the interactive form.

19. The article of manufacture of claim 17, wherein the instructions to receive the second data indicative of filling the data into the created UI of the interactive form comprises instructions which when executed by a computer, cause the computer to validate the data based on the information about the design and the data model of the one or more UI objects.

20. The article of manufacture of claim 14, wherein the instructions to store the UI of the interactive form in association with the recorded script further comprise instructions which when executed by a computer, cause the computer to save the interactive form in a file with a data schema.
